(19) United States
(12) Patent Application Publication
(10) Pub. No.: US 2012/0242281 A1
(43) Pub. Date: Sep. 27, 2012

(54) BATTERY PACK AND ELECTRONIC APPARATUS THEREOF

(76) Inventor: Wei-wei Liu, New Taipei City (TW)

(21) Appl. No.: 13/418,329

(22) Filed: Mar. 12, 2012

(30) Foreign Application Priority Data
Mar. 24, 2011 (CN) 201110072055.X

(51) Int. Cl. H02J 7/00

(52) U.S. Cl. 320/107; 320/134; 320/118; 320/162

(57) ABSTRACT

A battery pack comprising a plurality of batteries. Each of the batteries includes: a control circuit, for detecting power of the batteries to generate power information; and at least one transmitting interface, for outputting the power information, and for receiving external power or for outputting the power stored in the battery, wherein the control circuit further determines if the external power is utilized to charge the battery according to the power of the batteries.

### BACKGROUND OF THE INVENTION

1. Field of the Invention

The present invention relates to a battery pack and an electronic apparatus thereof, and particularly relates to a battery pack including a plurality of batteries, and an electronic apparatus thereof.

2. Description of the Prior Art

Conventionally, a mobile electronic apparatus such as a notebook always utilizes a single battery to provide power. However, such kind of batter is heavy thus is inconvenient to be applied to an electronic apparatus, since a modern electronic apparatus is desired to be as tiny as possible. Additionally, while only one battery is utilized to provide power, if the battery is broken and no charger can be acquired nearby, the electronic apparatus may completely exhausted power and can not operate.

### SUMMARY OF THE INVENTION

One object of the invention is to provide a battery pack including a plurality of batteries.

Another object of the invention is to provide an electronic apparatus utilizing a plurality of batteries.

Still another object of the invention is to provide a battery managing method for a plurality of batteries.

One embodiment of the invention provides a battery pack, comprising a plurality of batteries. Each of the batteries includes: a control circuit, for detecting power of the batteries to generate power information; and at least one transmitting interface, for outputting the power information, and for receiving external power or for outputting the power stored in the battery, wherein the control circuit further determines if the external power is utilized to charge the battery according to the power of the batteries.

Another embodiment of the invention provides an electronic apparatus comprising a plurality of batteries. Each of the batteries includes: a control circuit, for generating power information; and at least one transmitting interface, for outputting the power information, and for receiving charging power or for outputting the power stored in the battery; a power supplying device, for supplying the charging power; a battery managing circuit, coupled to the power supplying device and the batteries, for controlling the power supplying device to charge the batteries according to the power information; and a plurality of sockets, wherein the batteries are connected in parallel, where each one of the batteries utilizes the transmitting interface to be coupled to the battery managing circuit via the sockets.

Still another embodiment of the invention provides a battery managing method, applied to an electronic apparatus utilizing a plurality of batteries. The method comprises: utilizing a battery managing circuit to detect voltage values of the batteries; and determining if any new battery is coupled according to the voltage values, if yes, charging one battery with highest voltage among the batteries, if not, acquiring state information of the batteries.

In view of above-mentioned embodiments, the electronic apparatus can utilize different kinds of arrangement and numbers of batteries, to get a best balance of weight and power storage amount, for an electronic apparatus.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an electronic apparatus utilizing the battery pack according to an embodiment of the invention.

FIG. 2 is a schematic diagram illustrating that the batteries according to the first embodiment of the invention are respectively connected in parallel with an electronic apparatus.

FIG. 3 is a schematic diagram illustrating that the batteries according to the second embodiment of the invention are connected in series with an electronic apparatus.

FIG. 4 and FIG. 5 are block diagrams illustrating the electronic apparatus utilizing a plurality of batteries.

FIG. 6 is a schematic diagram illustrating how the power of batteries is displayed on the display.

FIG. 7 is a flowchart illustrating the battery managing method according to an embodiment of the invention.

### DETAILED DESCRIPTION

Please note that the following description and the figures are only for explanation, but do not mean to limit the scope of the present application. Besides, the term “couple” utilized below includes any direct and indirect electrical connection method.

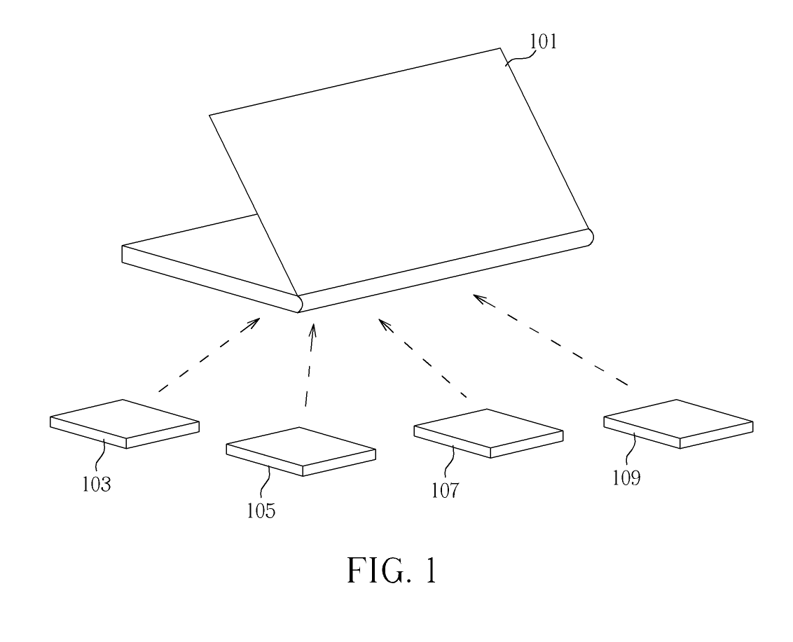

FIG. 1 is a schematic diagram illustrating an electronic apparatus utilizing the battery pack according to an embodiment of the invention. As shown in FIG. 1, the notebook 101 utilizes a plurality of batteries 103, 105 107 and 109.

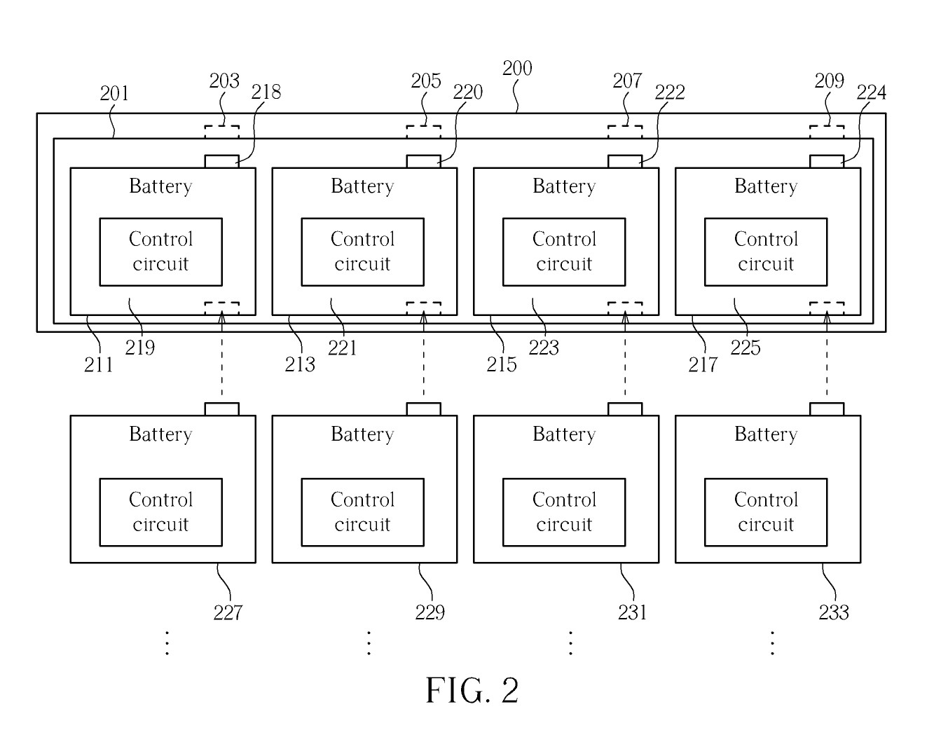

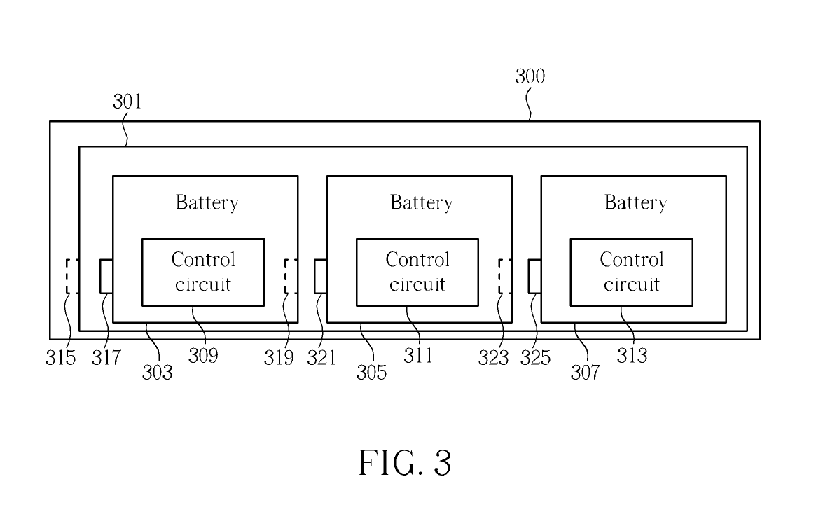

The following embodiment explains how the battery pack is set to the notebook 101, in series or in parallel. FIG. 2 illustrates a first embodiment of the present application. In the first embodiment, the batteries are connected in series. FIG. 3 illustrates a second embodiment of the present application. In the second embodiment, the batteries are connected in parallel.

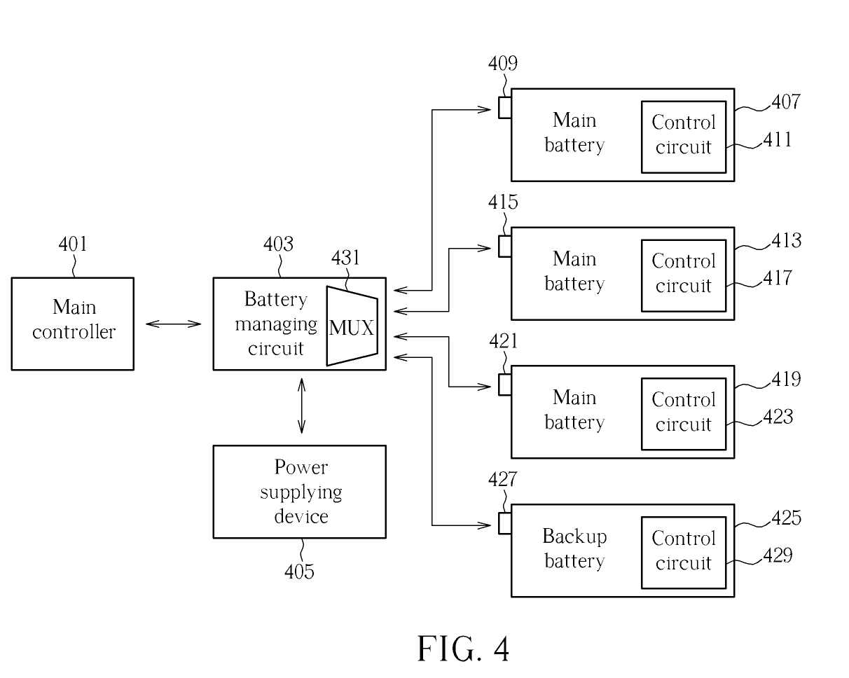

Please refer to FIG. 2, which is a schematic diagram illustrating that the batteries according to the first embodiment of the invention are respectively connected in parallel to an electronic apparatus. As shown in FIG. 2, the notebook 200 includes a battery through 201 and a plurality of sockets 203, 205, 207 and 209 distributed in the battery through 201. The batteries 211, 213, 215 and 217 respectively includes transmitting interfaces 218, 220, 222, 224 and control circuits 219, 221, 223 and 225. The control circuits 219, 221, 223 and 225 serve to generate power information of all batteries. The transmitting interfaces 218, 220, 222 and 224 serve to output power information to a battery managing circuit in the notebook (will be illustrated in FIG. 4), and serve to receive external power (in this example, the external power indicates the power received from the notebook transformer in the power charging mode)or to output the power stored in the batteries 211, 213, 215 and 217 to the notebook.

Please refer to FIG. 3, which is a schematic diagram illustrating that the batteries according to the second embodiment of the invention are connected in series with an electronic apparatus. Comparing to FIG. 2, the notebook 300 in FIG. 3 also includes a battery through 301, but includes only one socket 315 disposed in the battery through 301. The batteries 303, 305 and 307 respectively include transmitting interfaces 317, 319, 321, 323 and 325, and control circuits 309, 311 and 325. In this embodiment, the batteries 303, 305 and 307 are connected in series, that is, the battery 303 is coupled to the transmitting interface 315 of the notebook via the transmitting interface 317 thereof, such that it can be electrically coupled to a battery managing circuit of the notebook. Besides, the battery 305 is coupled to the transmitting interface 319 of the battery 303 through the transmitting interface 321 thereof. Besides, the battery 307 can be coupled to a transmitting interface 323 of the battery 305 via the transmitting interface thereof. Via such kind of arrangement, although the batteries 305 and 307 in FIG. 3 is not directly coupled to the computer such as in FIG. 2, the batteries can still exchange data with the computer, and receive/output power. Please note that the first embodiment shown in FIG. 1 can operate with the second embodiment shown in FIG. 3. For example, the first embodiment can further comprise batteries 227-233, which are respectively coupled to batteries 211-217 in series. Additionally, the batteries shown in FIG. 2 and FIG. 3 can respectively include different power storage ability.

In the embodiments shown in FIG. 2 and FIG. 3, the transmitting interfaces 203, 205, 207, 209, 218, 220, 222, 224, 315, 317, 319 ,321, 323 and 325 can be USB (Universal serial Bus) interfaces, but it does not mean to limit such kind of transmitting interface. Any transmitting interface that can transmit data and power should fall in the scope of the present invention. Additionally, the structure and battery numbers shown in FIG. 2 and FIG. 3 are only for explanation but do not mean to limit the scope of the present application.

The embodiments shown in FIG. 2 and FIG. 3 not only disclose the electronic apparatus utilizing the batteries but also a battery pack. This battery pack includes a plurality of batteries. Each of the batteries includes: a control circuit, for detecting power of the batteries to generate power information; and at least one transmitting interface, for outputting the power information, and for receiving external power or for outputting the power stored in the battery.

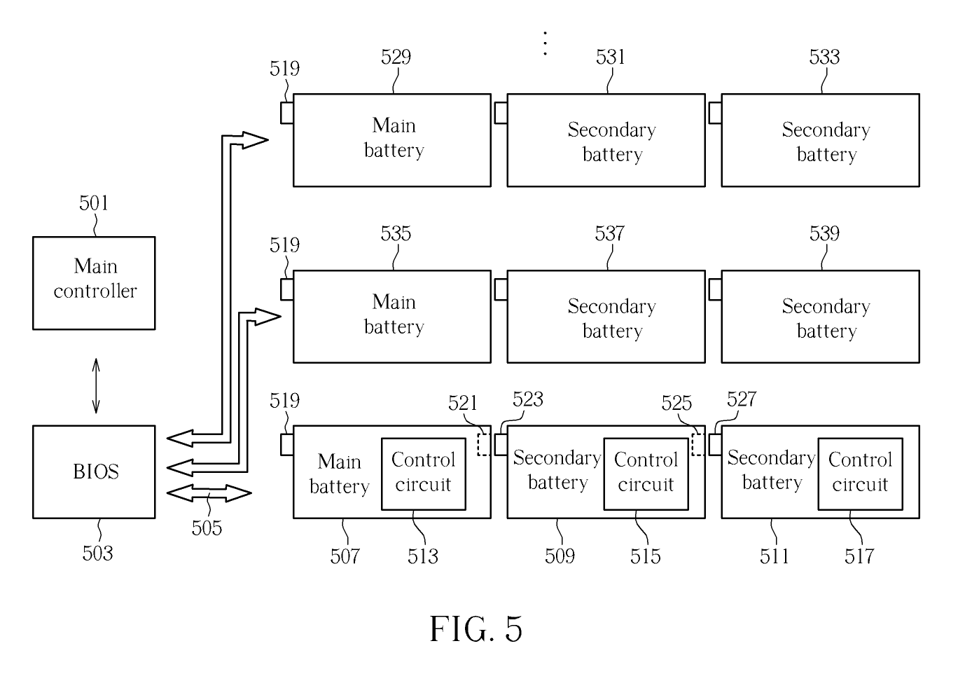

FIG. 4 and FIG. 5 are block diagrams illustrating the electronic apparatus utilizing a plurality of batteries. As shown in FIG. 4, the batteries 407, 413, 419 and 425 respectively include transmitting interfaces 409, 415, 421 and 427, and control circuits 411, 417, 423 and 429. As above-mentioned, the batteries 407, 413, 419 and 425 are coupled to the battery managing circuit 403 via the transmitting interfaces 409, 415, 421 and 427. The control circuits 411, 417, 423 and 429 generate power information and transmit to the battery managing circuit 403 via the transmitting interfaces 409, 415, 421 and 427. The battery managing circuit 403 controls the power supplying device 405 to charge the batteries 407, 413, 419 and 425 according to the power information. Besides, the transmitting interfaces 409, 415, 421 and 427 can operate in a power releasing mode to output power stored in the batteries 407, 413, 419 and 425. In one embodiment, the battery managing circuit 403 can further include a multiplexer 431, such that the transmitting of power information or power can be switched between a plurality of batteries. Additionally, some parts of the batteries 407, 413, 419 and 425 can be utilized for secondary batteries, and some are utilized as main batteries (in this embodiment, 407, 413 and 419). That is, the secondary batteries are not utilized in a normal state, they are only used when other batteries are exhausted.

FIG. 5 is a detail structure for the block diagrams shown in FIG. 4. As shown in FIG. 5, the batteries 507, 509 and 511 transmit data and power through the SMbus 505 and the BIOS (Basic Input/Output System) 503. The BIOS 503 can acquire related battery information from the control circuits 513, 515 and 517, and transmit to the main controller 501. The SMbus 505 and the BIOS 503 mentioned here are only one embodiment, but do not mean to limit the scope of the present application. Since how to acquire battery information and power from the batteries is well know by persons skilled in the art, it is omitted for brevity here.

In the circuit diagram corresponding to the second embodiment, the batteries 507, 509 and 511 are connected in series, but only the battery 507 is directly connected to the notebook via the transmitting interface 519. The battery 507 is utilized as the main battery, and the batteries 509, 511 are utilized as secondary batteries, which can charge the battery 507 when the battery 507 has insufficient power. It should be noted that the parallel connection shown in FIG. 2 and series connection shown in FIG. 3 can be combined. Accordingly, although FIG. 5 only discloses one series batteries connected in series, the disclosed concept can be applied to more than one battery series which are connected in series. For example, FIG. 5 can include the series-connected batteries composed of the main battery 529, the secondary batteries 531 and 533, and the series-connected batteries composed of the main battery 535, the secondary batteries 537 and 539.

The embodiments shown in FIGS. 4 and 5 can detect if any new battery is connected. If a new battery is connected, the control circuit of the battery will transmit information, such that a main controller of the notebook can be noticed that if any new battery is connected. The order of charging and discharging can be changed. In one embodiment, the battery with highest voltage is charged first, and the battery with lowest power has the first priority to supply power.

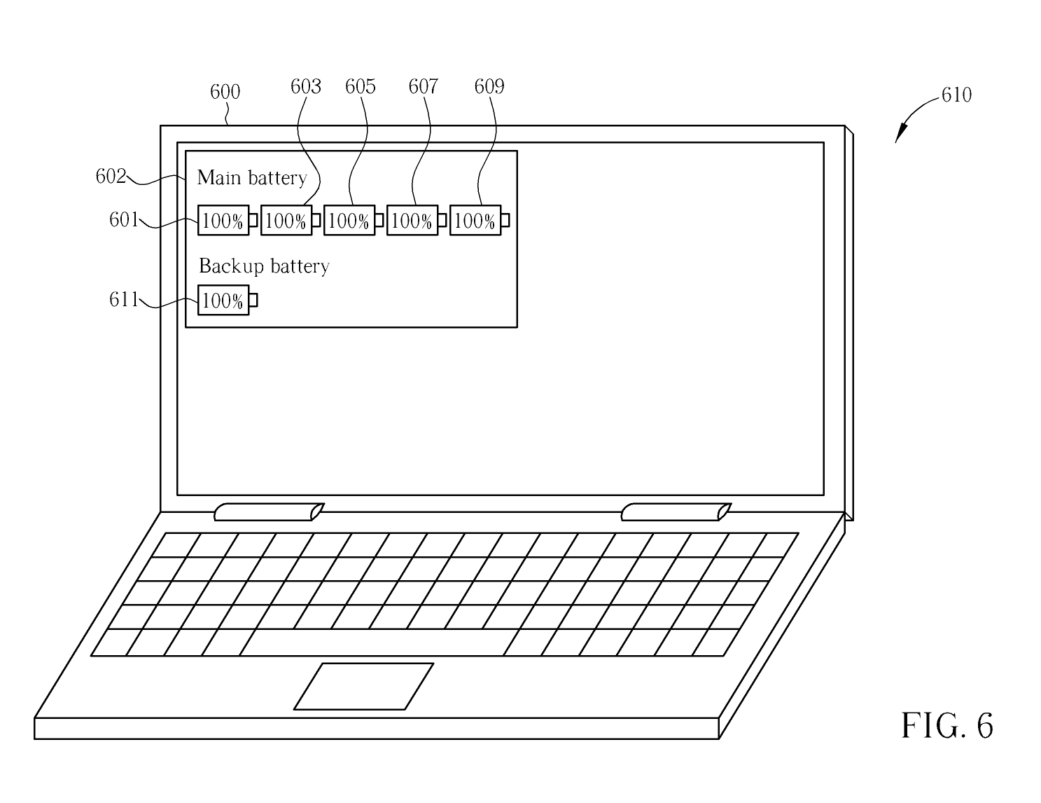

After acquiring battery information, the battery information can be displayed on the display. Such operation can be performed by the main controller 401 shown in FIG. 4 and the main controller 501 shown in FIG. 5. As shown in FIG. 6, the display 600 includes a window 602, which shows power of main batteries power icons 601, 603, 605, 607 and 609, and power of the secondary battery power icon 611. Thereby the user can rapidly understand power state of all the batteries. The display 600 can be the display of the notebook 610, such as in FIG. 6. However, the displays can be other types of displays if other types of electronic apparatuses are utilized. For example, the display can be independent from the body.

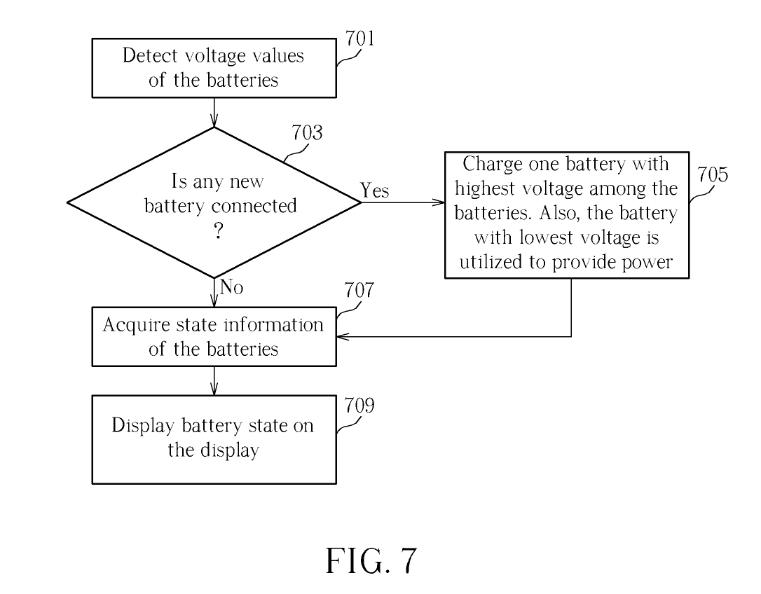

In view of above-mentioned embodiments, the present application also provides a battery managing method. FIG. 7 is a flow chart illustrating the battery managing method according to an embodiment of the invention. The method shown in FIG. 7 can include following steps:

Step 701

Detect voltage values of the batteries.

Step 703

Determine if any new battery is coupled according to the voltage values. If yes, go to step 705, if not, go to step 707.

Step 705

Charge one battery with highest voltage among the batteries. Also, the battery with lowest voltage is utilized to provide power.

Step 707

Acquire state information of the batteries.

One method to implement the step 707 is:

Utilize the USB interface as a negotiating interface of the main controller and the control circuit in the battery. Also, a register is utilized to register the data generated by the main controller and the control circuit in the battery. Accordingly, the USB interface sends the data registered by the register to the main controller, or transmits the data generated by the main controller to the register. Additionally, an initialization step is needed, that is, call battery driving entry function, and initialize parameters related with battery driving of the battery managing circuit. Besides, API (Application Programming Interface) function is called, to acquire information of battery state.

It should be noted that, the above implement for the step 707 is only for example but does not mean to limit the scope of the present application. Persons skilled in the art can acquire battery state information according to the concept of the present application. For example, the chip BQ26220 is a well known battery monitoring chip. Persons skilled in the art can utilize such chip to get battery state information.

Step 707

Display battery state on the display.

Other detail steps can be acquired via above-mentioned embodiments, thus it is omitted for brevity here.

Comparing with the prior art notebook that utilizes a single battery, the notebook disclosed in the present application utilizes a plurality of batteries. Accordingly, the user can decide how many batteries should be utilized based on different situations. For example, if the user knows that the notebook will be utilized in longtime that no external power supplying can be acquired, the user can put all the batteries into the notebook. On the other hand, if the user knows that he will carry the notebook and walk for a long distance but worries about some paper work are needed to be down, he can decrease the battery amounts and puts only one or two small batteries to the notebook to decrease the weight thereof. Besides, the batteries can be different kinds of batteries with different power and weight, thus the user can choose the combination of the batteries depending on what he need.

Those skilled in the art will readily observe that numerous modifications and alterations of the device and method may be made while retaining the teachings of the invention.

What is claimed is:

1. A battery pack, comprising:
a plurality of batteries, wherein each of the batteries includes:
a control circuit, for detecting power of the batteries to generate power information; and
at least one transmitting interface, for outputting the power information, and for receiving external power or for outputting the power stored in the battery, wherein the control circuit further determines if the external power is utilized to charge the battery according to the power of the batteries.

2. The battery pack of claim 1, wherein the batteries are connected in series via the transmitting interface.

3. An electronic apparatus, comprising:
a plurality of batteries, wherein each of the batteries includes:
a control circuit, for generating power information; and
at least one transmitting interface, for outputting the power information, and for receiving charging power or for outputting the power stored in the battery;
a power supplying device, for supplying the charging power;
a battery managing circuit, coupled to the power supplying device and the batteries, for controlling the power supplying device to charge the batteries according to the power information; and
a socket, wherein one main battery of the batteries is coupled to the battery managing circuit via the socket, and other ones of the batteries are coupled with the main battery in series via the transmitting interface.

4. The electronic apparatus of claim 3, wherein the battery managing circuit controls the power supplying device to provide the charging power to the battery with a highest voltage, and controls the battery with the lowest voltage to provide stored power, when a battery originally not coupled to the power supplying device is coupled to the power supplying device.

5. The electronic apparatus of claim 3, wherein the electronic apparatus further includes a display and a main controller, where the main controller displays power state of each battery according to the power information.

6. An electronic apparatus, comprising:
a plurality of batteries, wherein each of the batteries includes:
a control circuit, for generating power information; and
at least one transmitting interface, for outputting the power information, and for receiving charging power or for outputting the power stored in the battery;
a power supplying device, for supplying the charging power;
a battery managing circuit, coupled to the power supplying device and the batteries, for controlling the power supplying device to charge the batteries according to the power information; and
a plurality of sockets, wherein the batteries are connected in parallel, where each one of the batteries utilizes the transmitting interface to be coupled to the battery managing circuit via the sockets.

7. The electronic apparatus of claim 6, wherein the battery managing circuit controls the power supplying device to provide the charging power to the battery with a highest voltage, and controls the battery with the lowest voltage to provide stored power, when a battery originally not coupled to the power supplying device is coupled to the power supplying device.

8. The electronic apparatus of claim 6, wherein the electronic apparatus further includes a display and a main controller, where the main controller displays power state of each battery according to the power information.

9. A battery managing method, applied to an electronic apparatus utilizing a plurality of batteries, comprising:
utilizing a battery managing circuit to detect voltage values of the batteries; and
determining if any new battery is coupled according to the voltage values, if yes, charging one battery with highest voltage among the batteries, if not, acquiring state information of the batteries.

10. The battery managing method of claim 9, wherein the electronic apparatus includes: a transmitting interface, a main controller and a register, where the battery includes a control circuit, and the step of acquiring state information of the batteries includes:
utilizing the transmitting interface as a communicating interface of the main controller and the control circuit;
utilizing the register to register information generated by the main controller and the control circuit in the battery.

11. The battery managing method of claim 9, wherein the step of acquiring state information of the batteries includes:
calling battery driving entry function, and initializing parameters related with battery driving of the battery managing circuit.

12. The battery managing method of claim 9, wherein the step of acquiring state information of the batteries includes:
calling application programming interface function of the battery, to acquire information of the battery state.

13. The battery managing method of claim 9, further comprising:
displaying power state of each battery according to the state information.
